(19) United States
(12) Patent Application Publication
(10) Pub. No.: US 2026/0209052 A1
(43) Pub. Date: Jul. 23, 2026

(54) ANODE ACTIVE MATERIAL AND SOLID-STATE BATTERY

(71) Applicant: TOYOTA JIDOSHA KABUSHIKI KAISHA, Toyota-shi (JP)

(72) Inventor: Hikaru SUGANUMA, Susono-shi (JP)

(73) Assignee: TOYOTA JIDOSHA KABUSHIKI KAISHA, Toyota-shi (JP)

(21) Appl. No.: 19/448,542

(22) Filed: Jan. 14, 2026

(30) Foreign Application Priority Data
Jan. 20, 2025 (JP) 2025-008023
Nov. 21, 2025 (JP) 2025-202239

(51) Int. Cl. C01B 33/023; H01M 10/0562

(52) U.S. Cl. CPC C01B 33/023; H01M 10/0562; C01P 2004/50; C01P 2006/12; C01P 2006/40; H01M 2300/0068

(57) ABSTRACT

An anode active material including silicon-based particles, in which a ratio a/b of oxygen concentration a (% by mass) of the silicon-based particles determined by ONH elemental analysis, as to specific surface area b (m²/g) of the silicon-based particles determined by nitrogen gas adsorption, is a value of 0.03 or less.

### CROSS-REFERENCE TO RELATED APPLICATION

This application claims priority to Japanese Patent Application No. 2025-008023 filed on Jan. 20, 2025, and to Japanese Patent Application No. 2025-202239 filed on Nov. 21, 2025. The disclosure of each of the above-identified applications, including the specification, drawings, and claims, is incorporated by reference herein in its entirety.

### BACKGROUND

### 1. Technical Field

The present disclosure relates to an anode active material and a solid-state battery.

### 2. Description of Related Art

A variety of silicon-based materials have been developed as anode active materials.

For example, Japanese Unexamined Patent Application Publication No. 2005-243640 (JP 2005-243640 A) discloses an anode active material containing a silicon-based compound that is represented by a particular chemical formula, and a carbon material.

For example, Japanese Unexamined Patent Application Publication No. 2024-017797 (JP 2024-017797 A) discloses composite particles containing porous silicon particles and a binder.

### SUMMARY

When a silicon-based material was used as an anode active material, charging and discharging efficiency sometimes did not reach the expected value. It was thought that the cause was that the surface of silicon-based materials was oxidized during production thereof, converting the silicon into silicon oxide. It was thought that silicon-based materials with a high degree of oxidization (i.e., silicon partially converted to silicon oxide) were less likely to release Li ions, which are inserted during charging, at the time of discharging.

From the perspective of battery performance and safety, fluctuations in battery volume should be suppressed, but there is room for improvement regarding the expansion and contraction of the anode volume that occurs during charging and discharging when a silicon-based material is used as the anode active material.

The present disclosure has been made in view of the above circumstances.

An object of the present disclosure is to provide an anode active material that, when applied to an anode, has excellent charging and discharging efficiency and also suppresses expansion and contraction of anode volume accompanying charging and discharging.

Specific means for addressing the above issue include the following aspects.

<1>

An anode active material including
silicon-based particles, in which
a ratio a/b of oxygen concentration a (% by mass) of the silicon-based particles determined by ONH elemental analysis, as to specific surface area b (m²/g) of the silicon-based particles determined by nitrogen gas adsorption, is a value of 0.03 or less.
   <2>

The anode active material according to <1>, in which
the oxygen concentration a is 3.5% by mass to 6.0% by mass, and
the specific surface area b is 170 m²/g to 220 m²/g.
   <3>

The anode active material according to <1> or <2>, in which carbon concentration of the silicon-based particles is 2.0% by mass to 3.0% by mass as determined by CHN elemental analysis.

<4>

The anode active material according to any one of <1> to <3>, in which the silicon-based particles are agglomerated particles of primary particles of which an average aspect ratio is 1.1 or less.

<5>

A solid-state battery including an anode including an anode active material layer containing the anode active material according to any one of <1> to <4>.

An anode active material is provided that, when applied to an anode, has excellent charging and discharging efficiency and also suppresses expansion and contraction of anode volume accompanying charging and discharging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a partial sectional view illustrating an example of a layer structure of a solid-state battery.

### DETAILED DESCRIPTION OF EMBODIMENTS

Embodiments of the present disclosure will be described below. The following descriptions and examples are intended to illustrate the embodiments and are not intended to limit the scope of the embodiments.

In the present disclosure, the term “step” refers not only to an independent step but also includes a step that may not be clearly distinguishable from another step, as long as the intended purpose of the step is achieved.

In the present disclosure, the expression “A and/or B” has the same meaning as “at least one of A and B.” That is to say, “A and/or B” means A alone, B alone, or a combination of A and B.

In the present disclosure, numerical ranges indicated using “to” represent ranges inclusive of minimum values and maximum values specified before and after “to”, respectively. In numerical ranges described in stages in the present disclosure, the upper limit value or lower limit value of one numerical range may be replaced with the upper limit value or lower limit value of another numerical range that is described in stages. Also, in numerical ranges described in the present disclosure, the upper limit value or lower limit value of a numerical range may be replaced with a value disclosed in the examples.

In the present disclosure, when referring to the amount of each component in a composition, the amount refers to the total amount of all substances corresponding to the component that are present in the composition, unless otherwise specified, when multiple types of such substances are present.

### Anode Active Material

An anode active material of the present disclosure contains at least silicon-based particles. The anode active material according to the present disclosure may further contain other components (e.g., particles other than silicon-based particles, carbon compounds, and so forth).

### Silicon-Based Particles

Examples of silicon-based particles include crystalline Si particles, amorphous Si particles, silicide particles, Si alloy particles, silicon metal composite particles, silicon carbon compound composite particles, silicon carbon composite particles, porous silicon particles, and so forth.

The silicon-based particles that are contained in the anode active material according to the present disclosure have a ratio a/b of oxygen concentration a (% by mass) determined by ONH elemental analysis, as to specific surface area b (m²/g) determined by nitrogen gas adsorption, with a value of 0.03 or less. Silicon-based particles having a ratio a/b with a value of 0.03 or less have a low degree of oxidization regardless of having a large specific surface area, and therefore have excellent Li-ion charging and discharging efficiency. Silicon-based particles having a ratio a/b with a value of 0.03 or less have a relatively large specific surface area, i.e., micropores are developed, and voids in the micropores absorb volume expansion, thereby suppressing the expansion and contraction of the anode volume that accompanies charging and discharging.

From the above perspective, the value of the ratio a/b is preferably 0.02 or less. The lower limit value of the value of ratio a/b may be 0.00 or more.

From the perspective of excellent Li ion charging and discharging efficiency due to a low degree of oxidization, the oxygen concentration a of the silicon-based particles is preferably 6.5% by mass or less, more preferably 6.0% by mass or less, even more preferably 5.0% by mass or less, even more preferably 4.0% by mass or less, and particularly preferably 3.8% by mass or less. The lower limit value of the oxygen concentration a of the silicon-based particles may be 3.5% by mass or more. The oxygen concentration a of the silicon-based particles is a mass ratio (% by mass) of O as to the total amount of the three elements, which is determined by measuring the masses of O, N, and H, using an ONH elemental analyzer (so-called ONH meter).

From the perspective of suppressing expansion and contraction of the anode volume accompanying charging and discharging, the specific surface area b of the silicon-based particles is preferably 170 m²/g or more, more preferably 180 m²/g or more, even more preferably 190 m²/g or more, and even more preferably 200 m²/g or more. From the perspective of mechanical strength (i.e., resistance to crushing and resistance to collapsing of the silicon-based particles), the specific surface area b of the silicon-based particles is preferably 220 m²/g or less, more preferably 215 m²/g or less, and even more preferably 210 m²/g or less. The specific surface area b of the silicon-based particles is determined by the BET multipoint method, which is a gas adsorption method using nitrogen gas.

The silicon-based particles preferably contain carbon from the perspective of obtaining electronic conductivity and ionic conductivity exhibited by carbon. The silicon-based particles preferably have a carbon concentration of 2.0% by mass to 3.0% by mass, more preferably 2.2% by mass to 3.0% by mass, as determined by CHN elemental analysis. The carbon concentration of the silicon-based particles is the mass ratio (% by mass) of C as to the total amount of the three elements, which is determined by measuring the masses of C, H, and N using a CHN elemental analyzer (so-called CHN meter).

The silicon-based particles are preferably agglomerated particles that are formed by agglomerating primary particles having an average aspect ratio of 1.1 or less. When the average aspect ratio of the primary particles is 1.1 or less, surface area of the primary particles is relatively small, such that surface oxidization can be suppressed. When the silicon-based particles are agglomerated particles, voids exist between the individual particles, and these voids absorb the volume expansion, and accordingly the silicon-based particles have excellent performance in suppressing expansion and contraction of the anode volume that accompanies charging and discharging.

In the present disclosure, the aspect ratio of a particle is a ratio of the major axis length to the minor axis length (major axis/minor axis), and takes a value of 1 or more. The minor axis length of a particle is the length of the longest straight line among straight lines that are perpendicular to the major axis and connect opposing contour lines of the particle. In the present disclosure, the average aspect ratio of a particle is the average value of the aspect ratios of 100 particles. The aspect ratio of 100 particles is measured by observing the particles with a scanning electron microscope (SEM) and randomly selecting 100 particles from an SEM image in which a plurality of particle images is present in one field of view. When the number of particles in one field of view is less than 100, a plurality of SEM images is observed.

The silicon-based particles are agglomerated particles that are formed by agglomerating primary particles, and preferably have an average particle size of 4.0 μm to 7.0 μm, more preferably an average particle size of 4.5 μm to 7.0 μm, and even more preferably an average particle size of 4.9 μm to 6.5 μm. When the average particle size of the agglomerated particles is within the above range, the charging and discharging efficiency is excellent, and also the performance of suppressing expansion and contraction of the anode volume accompanying charging and discharging is excellent. The average particle size of the agglomerated particles is a median diameter (D50) based on the number of particles measured using a laser diffraction/scattering particle size distribution measurement instrument. Note that, the agglomerated particles may be crushed by pressing when forming the anode active material layer, and the particle size of the agglomerated particles that are contained in the anode active material layer is not necessarily within the above range.

When the silicon-based particles are agglomerated particles, the primary particles forming the agglomerated particles preferably have an average particle size of 0.8 μm to 1.5 μm, more preferably 0.85 μm to 1.4 μm, and even more preferably 0.89 μm to 1.3 μm. When the average particle size of the primary particles is within the above range, agglomerated particles of an appropriate size are readily formed. The average particle size of the primary particles is a median diameter (D50) based on the number of particles measured using a laser diffraction/scattering particle size distribution measurement instrument.

The silicon-based particles are preferably agglomerated particles of porous silicon particles (referred to as “porous silicon agglomerated particles”). The porous silicon agglomerated particles have porous silicon particles as primary particles, and in addition, are agglomerated particles of porous silicon particles, and therefore have excellent performance in suppressing expansion and contraction of the anode volume that accompanies charging and discharging. When the silicon-based particles are porous silicon agglomerated particles, it is preferable that the value of the ratio a/b, the oxygen concentration a, the specific surface area b, the carbon concentration, the average aspect ratio and average particle size of the primary particles, and the average particle size of the agglomerated particles are each within the above-described ranges in the porous silicon agglomerated particles.

An example of a method for producing silicon-based particles having a ratio a/b with a value of 0.03 or less includes a production method including the following step (a) to step (c).

Step (a): SiOₓ particles and an Mg compound are heated to convert the SiOₓ particles into precursor particles containing Mg, O, and Si.
Step (b): The precursor particles are mixed with an acid to dissolve the Mg and O in the precursor particles, and convert the precursor particles into porous silicon particles.
Step (c): The porous silicon particles are agglomerated to obtain porous silicon agglomerated particles.

The materials and methods for implementing step (a) to step (c) are described below.

### Step (a)

SiOₓ particles (where x is 1 or 2) are used as raw material particles for the silicon-based particles. SiO₂ particles are preferable as the raw material particles.

The SiOₓ particles are primary particles, and the average primary particle size is preferably 0.8 μm to 1.5 μm, more preferably 0.85 μm to 1.4 μm, and even more preferably 0.89 μm to 1.3 μm.

Examples of the shape of the SiOₓ particles include spherical, cuboid, plate-like, rod-like, or the like. The shape of the SiOₓ particles preferably has an average aspect ratio of 1.1 or less, from the perspective of suppressing surface oxidization due to a relatively small surface area.

Examples of the Mg compound to be reacted with the SiOₓ particles include metallic magnesium powder. It is presumed that the reaction between the SiOₓ particles and the metallic magnesium powder takes place according to the following formula.

SiOₓ+xMg→xMgO+Si

The amount of the Mg compound used is preferably 2 to 5 moles in terms of the amount of Mg per mole of SiOₓ particles, in order to allow the above reaction to proceed.

The heating in step (a) is carried out at a temperature and for a duration at which the components making up the SiOₓ particles react with the Mg compound. An example embodiment of heating is at a temperature of 750° C. for 10 to 20 hours in an inert atmosphere (e.g., in an Ar atmosphere).

### Step (b)

Step (b) is a step of making the precursor particles porous and performing conversion thereof into porous silicon particles. Step (b) is realized, for example, by mixing the precursor particles with an acid and stirring the mixture at room temperature.

For the acid, a strong acid is preferable from the perspective of reactivity with the precursor particles. Examples of strong acids include, for example, hydrochloric acid or nitric acid at pH 1. The amount of the strong acid used is preferably 5 to 10 moles per mole of the precursor particles.

### Step (c)

Step (c) is a step of agglomerating the porous silicon particles to obtain secondary particles. Any known particle agglomerating method can be applied to step (c). For example, a slurry containing porous silicon particles and a binder is prepared, and the slurry is treated by a spray drying method to dry and remove the solvent from the slurry, thereby obtaining porous silicon agglomerated particles. In this case, the porous silicon agglomerated particles may be composite particles containing porous silicon particles and a binder.

The binder is preferably a carbon compound that has properties of binding particles together. Examples of the binder include polymers such as butadiene rubber, butyl rubber, acrylate butadiene rubber, styrene butadiene rubber, polyvinylidene fluoride, polytetrafluoroethylene, polyimide, carboxymethyl cellulose, polyacrylic acid, polyacrylic acid ester, and so forth. The binder may be used as one type alone, or may be used as a mixture of two or more types.

Depending on the type of binder, firing in an inert atmosphere (e.g., in an Ar atmosphere) may be performed after the agglomerating treatment, as necessary.

According to the above-described production method, porous silicon agglomerated particles can be produced while suppressing oxidation of the particles, and accordingly silicon-based particles having a ratio a/b with a value of 0.03 or less can be readily obtained.

### Solid-State Battery

A solid-state battery according to the present disclosure includes a so-called all-solid-state battery that uses a solid electrolyte as an electrolyte. In the solid-state battery according to the present disclosure, the solid electrolyte may contain less than 10% by mass of an electrolytic solution relative to the total mass of the electrolyte, and may be a composite solid electrolyte containing both an inorganic solid electrolyte and a polymer electrolyte.

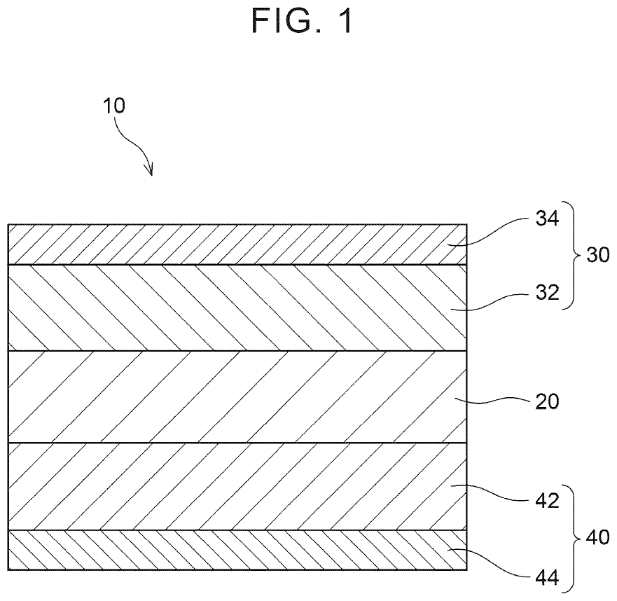

FIG. 1 is a partial sectional view illustrating an example of a layer structure of the solid-state battery of the present disclosure. A solid-state battery 10 that is illustrated in FIG. 1 includes a solid electrolyte layer 20, an anode 30, and a cathode 40. The anode 30 includes an anode active material layer 32 and an anode current collector 34. The cathode 40 includes a cathode active material layer 42 and a cathode current collector 44.

### Anode

The anode includes an anode active material layer containing the anode active material according to the present disclosure, and the anode current collector.

The anode active material layer contains silicon-based particles as the anode active material. The anode active material layer further contains, for example, an electrolyte, a conductive aid, and a binder. The respective contents of the active material, the electrolyte, the conductive aid, and the binder, in the anode active material layer can be set in accordance with desired battery performance. These materials are mixed to prepare an anode active material composite material, which is then pressed to form an anode active material layer.

Examples of the electrolyte include sulfide solid electrolytes and oxide solid electrolytes, and from the perspective of ion conductivity, sulfide solid electrolytes are preferable. Examples of the sulfide solid electrolyte include Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, Li₂S—P₂S₅—GeS₂, and so forth.

Examples of the conductive aid include carbon materials such as vapor grown carbon fiber, acetylene black, Ketjen black, carbon nanotubes, carbon nanofibers, and so forth; metal materials such as nickel, aluminum, stainless steel, and so forth, and the like. The conductive aid may be, for example, in the form of particles or fibers, and the size thereof is not limited in particular. The conductive aid may be used as one type alone or as a mixture of two or more types.

Examples of the binder include butadiene rubber, butyl rubber, acrylate butadiene rubber, styrene butadiene rubber, polyvinylidene fluoride, polytetrafluoroethylene, polyimide, carboxymethyl cellulose, polyacrylic acid, polyacrylic acid ester, and so forth. The binder may be used as one type alone, or may be used as a mixture of two or more types.

Examples of materials for the anode current collector include stainless steel, aluminum, copper, nickel, iron, titanium, carbon, and so forth. The form of the anode current collector is, for example, a foil or a mesh. The anode current collector is preferably a copper foil or a nickel foil.

### Solid Electrolyte

Examples of the solid electrolyte include a sulfide solid electrolyte and an oxide solid electrolyte, and from the perspective of ion conductivity, a sulfide solid electrolyte is preferred. The sulfide solid electrolyte may be the above-described compound.

### Cathode

The cathode includes a cathode active material layer and a cathode current collector. The cathode active material layer contains, for example, an active material, an electrolyte, a conductive aid, and a binder. The type and content of each of the active material, the electrolyte, the conductive aid, and the binder can be set in accordance with desired battery performance. The cathode current collector is preferably an aluminum alloy foil or an aluminum foil.

### Outer Encasement Member

Examples of an outer encasement member include an aluminum laminate film pack and a metal can.

The solid-state battery of the present disclosure is manufactured, for example, by the following first step and second step. The first step is a step of producing a laminate by laminating an anode current collector, an anode active material layer, a solid electrolyte layer, a cathode active material layer, and a cathode current collector. The second step is a step of housing the laminate in an outer encasement member, disposing an anode tab and a cathode tab, and vacuum sealing the laminate.

The shape and application of the solid-state battery according to the present disclosure are not limited. The solid-state battery of the present disclosure can be applied to, for example, hybrid electric vehicles (HEVs), plug-in hybrid electric vehicles (PHEVs), and battery electric vehicles (BEVs).

The silicon-based particles, the anode active material, and the solid-state battery according to the present disclosure will be described in further detail below with reference to Examples. The materials, processing procedures, processing conditions, and so forth, that are described in the Examples below can be modified as appropriate without departing from the spirit and scope of the present disclosure. Accordingly, the silicon-based particles, the anode active materials, and the solid-state batteries according to the present disclosure should not be construed as being limited by the specific examples given below.

Unless otherwise specified, synthesis, treatment, fabrication, and so forth in the following description were performed at room temperature (25° C.±3° C.).

### Examples 1, 2

SiO₂ particles having the average aspect ratios and particle sizes that are listed in Table 1 were prepared. The SiO₂ particles were mixed with metallic magnesium powder. The mixture was baked in an Ar atmosphere at a temperature of 750° C. for 10 to 20 hours to react with Mg, thereby converting the SiO₂ particles into precursor particles. The precursor particles were placed in hydrochloric acid of pH 1 to dissolve the MgO that is contained in the precursor particles, making the primary particles porous and performing conversion thereof into porous silicon particles. Polyvinylidene fluoride was dissolved in an organic solvent, and the porous silicon particles and a dispersant were further dispersed therein to prepare a slurry. Using this slurry as a material, the porous silicon particles were bound by polyvinylidene fluoride by spray drying, so as to form agglomerated particles. The agglomerated particles (i.e., composite particles containing porous silicon particles and polyvinylidene fluoride) were used as the anode active material.

### Comparative Examples 1, 2

SiOₓ particles (where x is 1 or 2), having the average aspect ratio and particle size shown in Table 1, were prepared. The SiOₓ particles were mixed with metallic magnesium powder. The mixture was baked in an Ar atmosphere at a temperature of 750° C. for 10 to 20 hours to react with Mg, thereby converting the SiOₓ particles into precursor particles. The precursor particles were placed in hydrochloric acid of pH 1 to dissolve the MgO that is contained in the precursor particles, making the primary particles porous and performing conversion thereof into porous silicon particles. These porous silicon particles were used as the anode active material.

### Comparative Example 3

SiOₓ particles (where x is 1 or 2), having the average aspect ratio and particle size shown in Table 1, were prepared. The SiOₓ particles were mixed with metallic magnesium powder. The mixture was baked in an Ar atmosphere at a temperature of 850° C. for 10 to 20 hours to react with the Mg, thereby converting the SiOₓ particles into precursor particles. The precursor particles were placed in hydrochloric acid of pH 1 to dissolve the MgO that is contained in the precursor particles, making the primary particles porous and performing conversion thereof into porous silicon particles. These porous silicon particles were used as the anode active material.

### Comparative Example 4

SiOₓ particles (where x is 1 or 2), having the average aspect ratio and particle size shown in Table 1, were prepared. The SiOₓ particles were mixed with metallic magnesium powder. The mixture was baked in an Ar atmosphere at a temperature of 800° C. for 10 to 20 hours to react with the Mg, thereby converting the SiOₓ particles into precursor particles. The precursor particles were placed in hydrochloric acid of pH 1 to dissolve the MgO that is contained in the precursor particles, making the primary particles porous and performing conversion thereof into porous silicon particles. These porous silicon particles were used as the anode active material.

### Comparative Examples 5, 6

Single-crystal Si powder was used as the anode active material.

### Manufacturing of Evaluation Batteries

### Production of Sulfide Solid Electrolyte

Li₂S 0.550 g
P₂S₅ 0.887 g
LiI 0.285 g
LiBr 0.277 g
n-heptane (dehydrated grade) 4 g

The above materials, excluding the n-heptane, were mixed in an agate mortar for 5 minutes. The n-heptane was added, and the mixture was mechanically milled in a planetary ball mill for 40 hours to obtain a sulfide solid electrolyte.

### Production of Anode Active Material Composite Material

Anode active material (silicon-based particles, product of Examples and Comparative Examples) 1.0 g
Sulfide solid electrolyte 0.776 g
Conductive aid: Vapor grown carbon fiber (VGCF, Resonac Co., Ltd.) 0.04 g
Binder: Polyvinylidene fluoride 0.02 g
Butyl butyrate 1.7 g

The above materials were mixed with an ultrasonic homogenizer to obtain an anode active material composite material.

### Production of Cathode Active Material

LiNi_{1/3}Co_{1/3}Mn_{1/3}O₂ was surface-treated with LiNbO₃ to obtain a cathode active material.

### Production of Cathode Active Material Composite Material

Cathode Active Material 1.5 g
Sulfide solid electrolyte 0.239 g
Conductive aid: Vapor grown carbon fiber (VGCF, Resonac Co., Ltd.) 0.023 g
Binder: Polyvinylidene fluoride 0.011 g
Butyl butyrate 0.8 g

The above materials were mixed in an ultrasonic homogenizer to obtain a cathode active material composite material.

### Manufacturing of All-Solid-State Battery

The sulfide solid electrolyte, the anode active material composite material, and the cathode active material composite material were each formed into a strip shape. The anode active material layer and the solid electrolyte layer were laminated and roll pressed at a pressure of 50 kN/cm. Al foil serving as a release sheet was peeled off from the solid electrolyte layer, thereby transferring the solid electrolyte layer onto the anode active material layer. The anode active material layer onto which the solid electrolyte layer was transferred was punched into a circle having a diameter of 13.00 mm, using a punching machine. The cathode active material layer and the solid electrolyte layer were laminated and roll pressed at a pressure of 50 kN/cm. Al foil serving as a release sheet was peeled off from the solid electrolyte layer, thereby transferring the solid electrolyte layer onto the cathode active material layer. The cathode active material layer onto which the solid electrolyte layer was transferred was punched into a circle having a diameter of 11.28 mm, using a punching machine. Another solid electrolyte layer punched out into a circle of a predetermined size was further transferred onto the solid electrolyte layer that was laminated on the anode active material layer, using a uniaxial press. The solid electrolyte layer side of the anode active material layer, and the solid electrolyte layer side of the cathode active material layer, were laminated facing each other. Current extraction tabs were attached to the anode active material layer and the cathode active material layer, housed in an Al laminate film pack, sealed using a vacuum laminate sealer, and restrained under a pressure of 5 MPa. Thus, an all-solid-state battery was obtained.

### Measurement of Physical Properties and Performance Evaluation

### Average Aspect Ratio of Particles

The aspect ratios (major axis/minor axis) of 100 particles that were randomly selected from an SEM image were measured, and the average value was calculated.

### Particle Size (μm)

A number-based median diameter (D50) was determined using a laser diffraction/scattering particle size distribution measuring instrument.

Specific Surface Area (m²/g) of Particles

Determined by multipoint BET method, which is a gas adsorption method using nitrogen gas.

### Oxygen Concentration of Particles (%)

The masses of O, N, and H were measured using an ONH elemental analyzer (so-called ONH meter), and the mass ratio of O as to the total amount of the three elements was determined.

### Carbon Concentration of Particles (%)

The masses of C, H, and N were measured using a CHN elemental analyzer (a so-called CHN analyzer), and the mass ratio of C as to the total amount of the three elements was determined.

### Initial Charging and Discharging Efficiency (%)

The evaluation battery was charged at a constant current and constant voltage at 0.245 mA up to 4.55 V, and then discharged at a constant current and constant voltage at 0.245 mA down to 3.0 V. The initial charging and discharging efficiency (%)=(initial discharge capacity/initial charge capacity)×100 was calculated. The indices of the initial charging and discharging efficiency of the Examples and Comparative Examples were calculated, with the initial charging and discharging efficiency of Comparative Example 1 as 100.

### Amount of Increase in Restraining Pressure (MPa/mAh)

The evaluation battery was charged at a constant current and constant voltage at 0.245 mA up to 4.55 V, and then discharged at a constant current and constant voltage at 0.245 mA down to 3.0 V. During this charging and discharging, the restraining pressure of the battery (MPa/mAh) was monitored. The initial restraining pressure was subtracted from the restraining pressure at 4.55 V to obtain the amount in increase of the restraining pressure. Indices for amount of increase in the restraining pressure for the Examples and Comparative Examples were calculated with the amount of increase in the restraining pressure in Comparative Example 1 as 100.

TABLE 1

| | Primary particles | | | | | | | | Index of | | |
|---|---|---|---|---|---|---|---|---|---|---|---|
| | (raw material | | | | | | | Initial | initial | | Index of |
| | particles) | | Silicon-based particles | | | | | charging | charging | Amount of | amount of |
| | Average | | Secondary | Oxygen | Specific | a/b | Carbon | and | and | increase in | increase in |
| | aspect | Particle | particle | concentra- | surface | % by | concen- | discharging | discharging | restraining | restraining |
| | ratio | size | size | tion a | area b | mass/ | tration | efficiency | efficiency | pressure | pressure |
| | — | μm | μm | % by mass | m²/g | m²/g | % by mass | % | — | MPa/mAh | — |
| Comparative | 1.1 or | 1.3 | — | 8.9 | 171.6 | 0.05 | 0.9 | 82.7 | 100 | 0.24 | 100 |
| Example 1 | less | | | | | | | | | | |
| Comparative | 1.1 or | 0.89 | — | 7.2 | 162.7 | 0.04 | 0.8 | 81.1 | 98.07 | 0.23 | 95.83 |
| Example 2 | less | | | | | | | | | | |
| Comparative | 1.1 or | 1.3 | — | 3.3 | 31.7 | 0.10 | 0.9 | 90 | 108.83 | 0.43 | 179.17 |
| Example 3 | less | | | | | | | | | | |
| Comparative | 1.1 or | 1.3 | — | 5.6 | 77.9 | 0.07 | 0.9 | 83.7 | 101.21 | 0.27 | 112.50 |
| Example 4 | less | | | | | | | | | | |
| Example 1 | 1.1 or | 0.89 | 4.9 | 6.01 | 210.6 | 0.03 | 2.3 | 85.5 | 103.39 | 0.22 | 91.67 |
| | less | | | | | | | | | | |
| Example 2 | 1.1 or | 1.3 | 6.5 | 3.79 | 174.9 | 0.02 | 2.4 | 87.7 | 106.05 | 0.19 | 79.17 |
| | less | | | | | | | | | | |
| Comparative | 1.2 or | 1.0 | — | 0.84 | 11 | 0.08 | 0.2 | 92.5 | 111.85 | 0.55 | 229.17 |
| Example 5 | higher | | | | | | | | | | |
| Comparative | 1.2 or | 0.5 | — | 2.8 | 26.5 | 0.11 | 0.4 | 89.5 | 108.22 | 0.43 | 179.17 |
| Example 6 | higher | | | | | | | | | | |

The silicon-based particles of Examples 1 and 2, in which the ratio a/b was a value of 0.03 or less, were excellent in the initial charging and discharging efficiency, and also the amount in increase in the restraining pressure of the battery was small.

What is claimed is:

1. An anode active material comprising silicon-based particles, wherein a ratio a/b of oxygen concentration a (% by mass) of the silicon-based particles determined by ONH elemental analysis, as to specific surface area b (m²/g) of the silicon-based particles determined by nitrogen gas adsorption, is a value of 0.03 or less.

2. The anode active material according to claim 1, wherein:
the oxygen concentration a is 3.5% by mass to 6.0% by mass; and
the specific surface area b is 170 m²/g to 220 m²/g.

3. The anode active material according to claim 1, wherein carbon concentration of the silicon-based particles is 2.0% by mass to 3.0% by mass as determined by CHN elemental analysis.

4. The anode active material according to claim 1, wherein the silicon-based particles are agglomerated particles of primary particles of which an average aspect ratio is 1.1 or less.

5. A solid-state battery comprising an anode including an anode active material layer containing the anode active material according to claim 1.
